(19) United States
(12) Patent Application Publication
(10) Pub. No.: US 2017/0195085 A1
(43) Pub. Date: Jul. 6, 2017

(54) TRANSMISSION CONTROL PROTOCOL SEGMENT RECOVERY

(71) Applicant: Futurewei Technologies, Inc., Plano, TX (US)

(72) Inventors: Serhat Nazim AVCI, Milpitas, CA (US); Zhenjiang LI, San Jose, CA (US); Fangping LIU, San Jose, CA (US)

(73) Assignee: Futurewei Technologies, Inc., Plano, TX (US)

(21) Appl. No.: 14/989,720

(22) Filed: Jan. 6, 2016

(51) Int. Cl. H04L 1/16; H04L 12/801

(52) U.S. Cl. CPC H04L 1/1642; H04L 47/34

(57) ABSTRACT

A transmitting device implements a method for recovering TCP segments. The transmitting device transmits a plurality of transmission control protocol (TCP) segments to a receiving device one by one in sequence. After the transmission of the TCP segments, the transmitting device receives one or more TCP responses sent by the receiving device. Based on the received one or more TCP responses, the transmitting device identifies one or more TCP segments having communication failures. After the one or more TCP segments are identified, the transmitting device generates a probe based on the identified one or more TCP segments. With the probe, the transmitting device transmits a recovery TCP segment carrying the probe to the receiving device.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Transmission Control Protocol (TCP) is a core protocol of the Internet protocol suite. It originated in the initial network implementation in which it complemented the Internet Protocol (IP). Therefore, the entire suite is commonly referred to as TCP/IP. TCP provides reliable, ordered, and error-checked delivery of a stream of octets between applications running on hosts communicating over an IP network. TCP is the protocol that major Internet applications such as the World Wide Web, email, remote administration and file transfer rely on. Applications that do not require reliable data stream service may use the User Datagram Protocol (UDP), which provides a connectionless datagram service that emphasizes reduced latency over reliability.

TCP provides a communication service at an intermediate level between an application program and the Internet Protocol. It provides host-to-host connectivity at the Transport Layer of the Internet model. An application does not need to know the particular mechanisms for sending data via a link to another host, such as the required packet fragmentation on the transmission medium.

TCP is a reliable stream delivery service that guarantees that all bytes received will be identical with bytes sent and in the correct order. Since packet transfer over many networks is not reliable, a technique known as positive acknowledgment with retransmission is used to guarantee reliability of packet transfers. This fundamental technique requires the receiver to respond with an acknowledgment message as it receives the data. The sender keeps a record of each packet it sends. The sender also maintains a timer from when the packet was sent, and retransmits a packet if the timer expires before the message has been acknowledged. The timer is needed in case a packet obtains lost or corrupted.

### SUMMARY

In one embodiment, the disclosure includes a device including a memory storage comprising computer-executable instructions; and a processor coupled to the memory storage. The processor is configured to execute the instructions to: transmit a plurality of transmission control protocol (TCP) segments to a receiving device one by one in sequence; receive one or more TCP responses sent by the receiving device, where the one or more TCP responses are associated with the plurality of TCP segments; identify one or more TCP segments having communication failures based on the received one or more TCP responses; generate a probe based on the identified one or more TCP segments; and transmit a recovery TCP segment carrying the probe to the receiving device.

In another embodiment, the disclosure includes method for recovering TCP segments. The method includes: transmitting, by a transmitting device, a plurality of transmission control protocol (TCP) segments to a receiving device one by one in sequence; receiving, by the transmitting device, one or more TCP responses transmitted by the receiving device, where the one or more TCP responses are associated with the plurality of TCP segments; identifying, by the transmitting device, one or more TCP segments having communication failures based on the received one or more TCP responses; generating, by the transmitting device, a probe based on the identified one or more TCP segments; and transmitting, by the transmitting device, a recovery TCP segment carrying the probe to the receiving device.

In yet another embodiment, the disclosure includes non-transitory computer readable medium storing computer readable instructions which, when executed by a processor, cause the computer to perform a method. The method includes: transmitting a plurality of transmission control protocol (TCP) segments to a receiving device one by one in sequence; receiving one or more TCP responses sent by the receiving device, where the one or more TCP responses are associated with the plurality of TCP segments; identifying one or more TCP segments having communication failures based on the received one or more TCP responses; generating a probe based on the identified one or more TCP segments; and transmitting a recovery TCP segment carrying the probe to the receiving device.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 illustrates a schematic diagram of a network according to an embodiment of the disclosure.

FIG. 2 illustrates a flow chart showing a method of recovering one or more TCP segments according to an embodiment of the disclosure.

FIG. 3a illustrates a schematic diagram showing the TCP segment transmission and acknowledgement between two devices in accordance with an embodiment of the present disclosure.

FIG. 3b illustrates a schematic diagram showing a method of generating a probe by encoding two TCP segments according to an embodiment of the present disclosure.

FIG. 3c illustrates a schematic diagram of generating a decoding probe according to an embodiment of the present disclosure.

FIG. 3d illustrates a schematic diagram showing the recovery of the payload of a TCP segment according to an embodiment of the present disclosure.

FIG. 3e illustrates another schematic diagram of generating a probe according to an embodiment of the present disclosure.

FIG. 3f illustrates another schematic diagram showing the recovery of the payload of a TCP segment according to an embodiment of the present disclosure.

FIG. 4 illustrates a schematic diagram showing the recovery of payloads of TCP segments according to an embodiment of the present disclosure.

FIG. 5 illustrates a schematic diagram showing the recovery of TCP segments according to an embodiment of the present disclosure.

FIG. 6 illustrates a schematic diagram showing the recovery of the payloads of TCP segments according to an embodiment of the present disclosure.

FIG. 7 illustrates a schematic diagram showing the recovery of TCP segments according to an embodiment of the present disclosure.

FIG. 8 illustrates a schematic diagram showing the recovery of TCP segments according to an embodiment of the present disclosure.

FIG. 9 illustrates a schematic diagram showing the recovery of TCP segments according to an embodiment of the present disclosure.

### DETAILED DESCRIPTION

It should be understood at the outset that, although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

TCP is a protocol used by a receiver to receive the segments transmitted from a corresponding transmitter. In one implementation, after a transmitter transmits a plurality of TCP segments to a receiver, the transmitter further transmits a recovery TCP segment to the receiver without considering acknowledgements (ACKs) associated with the plurality of TCP segments. The payload of the recovery TCP segment is generated by encoding the payloads of all of the plurality of TCP segments before any ACK is received by the transmitter. When a portion of the plurality of TCP segments are not received, the receiver recovers the payloads of the TCP segments not being received by the receiver based on the recovery TCP segment. In this implementation, the transmitter needs to transmit the recovery TCP segment even when ACKs indicate that all of the TCP segments are received by the receiver.

In one embodiment of the present disclosure, a transmitter may transmit a plurality of TCP segments to a receiver. Based on acknowledgments (ACKs) associated with the plurality of TCP segments from the receiver, the transmitter may determine the TCP segment(s) having communication failures. For example, when the transmitter fails to receive an ACK associated with a TCP segment within a predefined receiving time period, the transmitter determines that the TCP segment has communication failures. After the TCP segment(s) having communication failures are determined, the transmitter may generate a probe based on the TCP segment(s) having communication failures, rather than based on all of the TCP. Furthermore, the transmitter may transmit the probe in a recovery TCP segment to the receiver so that the receiver may implement TCP segment recovery based on the probe. In the embodiment, the recovery TCP segment is transmitted when some TCP segments have communication failures. In other words, no TCP segment needs to be transmitted when the ACKs indicates that all of the TCP segments are received by the receiver. Thus, bandwidth between the transmitter and the receiver may be saved in this embodiment.

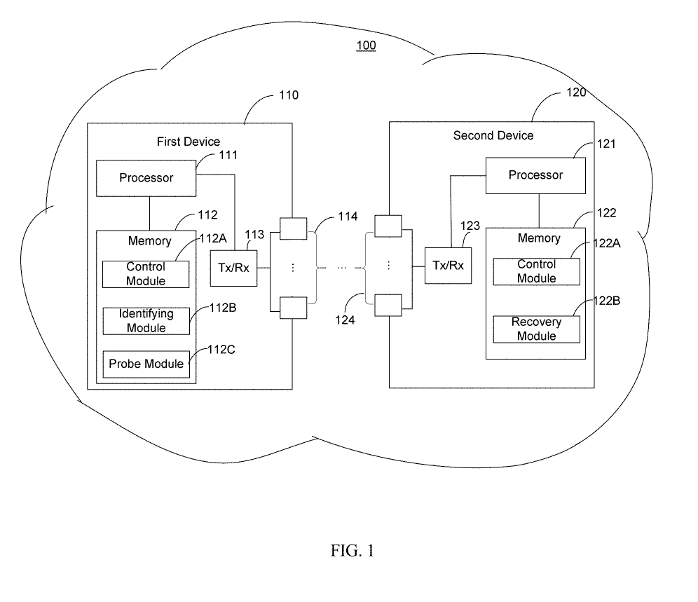

FIG. 1 illustrates a schematic diagram of a network 100 according to an embodiment of the disclosure. The network 100 may include a plurality of devices, such as device 110 and device 120, as shown in FIG. 1. The network 100 may include sub-networks, each of which may be a wireless personal area network, a local area network (LAN), a campus area network (CAN), metropolitan area network (MAN) or wide area network (WAN). Device 110 and device 120 may be included in one of the sub-networks, or in two different sub-networks respectively. The two different sub-networks may be same type or be different types. For example, device 110 and device 120 may be included in two wireless personal area networks in network 100 or may be included in a wireless personal area network and a LAN respectively. Devices 110 and 120 may be coupled with each other via one or more wired or wireless connections, or combination of wired and wireless connections. The wired connections between device 110 and device 120 may be based on metal or fiber wire, and the wireless connections between device 110 and device 120 may be based on wireless local area network (WLAN), global system for mobile (GSM), code division multiple access (CDMA), wideband code division access (WCDMA) and/or long-term evolution (LTE). Both device 110 and device 120 support transmission control protocol (TCP). Each of device 110 and device 120 may be a server, a computer, a laptop, a smart phone, a router or a switch, etc. Device 110 and device 120 may be the same type or different type of devices. For example, device 110 and device 120 may be two smart phones, or may be a laptop and a server respectively.

As shown in FIG. 1, device 110 includes a processor 111, a memory 112 coupled to processor 111, a transceivers (Tx/Rx) 113, and ports 114 coupled to Tx/Rx 113. Processor 111 may be implemented as a general processor or may be part of one or more application specific integrated circuits (ASICs) and/or digital signal processors (DSPs). Memory 112 may include a cache for temporarily storing content, e.g., a random-access memory (RAM). Additionally, memory 112 may include a long-term storage, e.g., a read-only memory (ROM). In one embodiment, memory 112 may includes multiple program modules, such as control module 112A, identifying module 112B, and probe module 112C. Device 120 includes a processor 121, a memory 122 coupled to processor 121, a transceivers (Tx/Rx) 123 and a plurality of ports 124 coupled to Tx/Rx 123. Processor 121 may be implemented as a general processor, or may be part of one or more application specific integrated circuits (ASICs) and/or digital signal processors (DSPs). Memory 122 may include a cache for temporarily storing content, e.g., a random-access memory (RAM). Additionally, memory 122 may include a long-term storage, e.g., a read-only memory (ROM). In one embodiment, memory 122 may include multiple program modules, such as control module 122A and recovery module 122B. Device 110 may sequentially transmit TCP segments to device 120. Each of the TCP segments has its own sequence number. In one embodiment, a sequence number may refer to the sequence number defined in Request for Comments (RFC) 792, 1122, 3168, 6093 or 6528. After receiving the TCP segments, device 120 may transmit acknowledgements (ACKs) respectively associated with the TCP segments back to device 110. When device 110 receives the ACKs associated with all of the TCP segments transmitted, device 110 may determine that all of the TCP segments are received by device 120. When device 110 fails to receive some ACKs, device 110 may determine that some of the TCP segments are not received by device 120.

It is understood that by programming and/or loading executable instructions onto the devices 110 and 120, at least one of the processor 111 and/or memory device 112 and at least one of processor 121 and/or memory device 122 are changed, transforming devices 110 and 120 in part into two particular machines or apparatuses having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an ASIC, because for large production runs the hardware implementation may be less expensive than the software implementation. Often a design may be developed and tested in a software form and later transformed, by well-known design rules, to an equivalent hardware implementation in an ASIC that hardwires the instructions of the software. In the same manner as a machine controlled by a new ASIC is a particular machine or apparatus, likewise a computer that has been programmed and/or loaded with executable instructions may be viewed as a particular machine or apparatus.

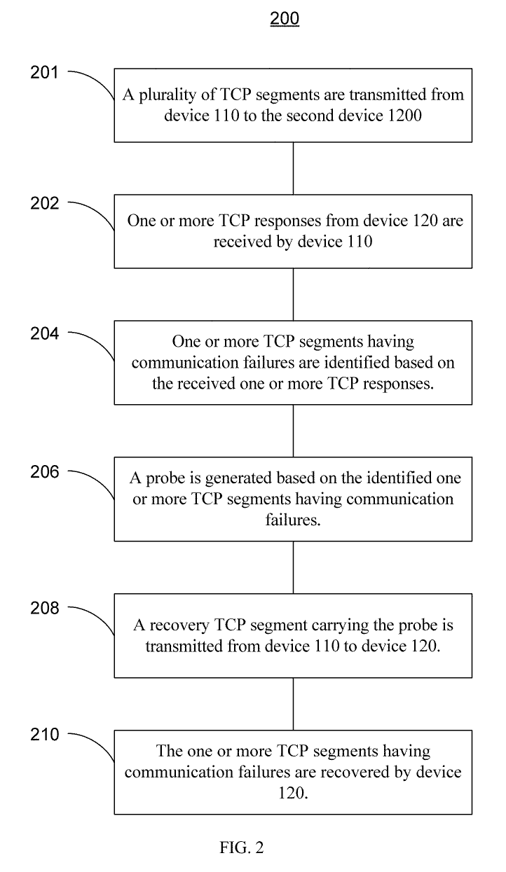

FIG. 2 illustrates a flow chart 200 showing a method of recovering one or more TCP segments according to one embodiment of the disclosure.

In block 201, a plurality of TCP segments are transmitted from device 110 to device 120. For example, processor 111 of device 110, when implementing a program in control module 112A, may instruct Tx/Rx 113 to transmit the TCP segments from device 110 to device 120 via a port 114.

In block 202, one or more TCP responses are received, by device 110, from device 120. In one embodiment, due to transmission failures, one or more TCP segments, which are transmitted from device 110, may not be received by device 120. Therefore, device 120 may receive a part of the plurality of TCP segments from device 110 via a port 124 and Tx/Rx 123. For example, in response to the received one or more TCP segments, processor 121 of device 120, when implementing a program in control module 122A, may instruct Tx/Rx 123 to transmit one or more responses to device 110 via a port 124. In one embodiment, the one or more TCP responses may be acknowledgements (ACKs), such as cumulative ACKS or selective ACKs. In another embodiment, the one or more TCP responses may carry acknowledgment information indicating which TCP segment or segments are received by the receiving device, such as device 120. The acknowledgment information may be used to identify the TCP segment or segments having communication failures. The acknowledgment information may be one or more acknowledgment numbers. An acknowledgment number in an ACK responsive to a TCP segment may be the total length of a sequence number in the TCP segment and a payload of the TCP segment. The total length may be used as a sequence number of a next TCP segment.

In block 204, one or more TCP segments having communication failures may be identified by device 110, based on the received one or more TCP responses. For example, processor 111 of device 110, when implementing a program in identifying module 112B, may identify which TCP segment is received by device 120, based on the acknowledgment information in the corresponding TCP response sent by device 120. Then, processor 111 may, when implementing a program in identifying module 112B, identify one or more TCP segments having communication failures based on the plurality of TCP segments transmitted to device 120 and the one or more TCP segments identified as being received by device 120. The one or more TCP segments having communication failures are obtained based on the difference between the plurality of TCP segments transmitted to device 120 and the one or more TCP segments identified as being received by device 120. For example, after device 110 transmits five TCP segments one by one in sequence from device 110 to device 120 and receives, during a pre-defined receiving time period, device 110 receives two responses, with one response indicating the first of the five TCP segments is received and another response indicating the third of the five TCP segments is received. Based on the received two responses by device 110, processor 111 identifies the second, the fourth and fifth of the five TCP segments as TCP segments having communication failures. In one embodiment, after a TCP segment, transmitted by device 110, is received by device 120, a TCP response, associated with the received TCP segment, may be transmitted by device 120. However, this transmitted TCP response may be failed to be received by device 110 during the pre-defined receiving time period. Thus, the TCP segment transmitted by device 110 may be considered as being not received by device 120 or as having communication failures. In one embodiment, the pre-defined receiving time period may be 2×Round Trip Time (RTT).

In block 206, a probe may be generated by device 110, based on the identified one or more TCP segments having communication failures. In one embodiment, when there is only one TCP segment having communication failures, processor 111 of device 110, while implementing a program in probe module 112C, may determine whether the payload of this TCP segment has the same length as Maximum Segment Size (MSS). MSS is a parameter of the Options field of a TCP header that specifies the largest amount of data (payload), measured in octets, that a computer or communications device can receive in a single TCP segment. MSS may not include the TCP header or the IP header. MSS may be negotiated by device 110 and device 120.

In block 208, a recovery TCP segment carrying the probe may be transmitted by device 110 to device 120. A recovery TCP segment may also be referred to as a recovery segment. After the probe is generated, processor 111 of device 110, when implementing a program in control module 112A, may transmit the recovery TCP segment to device 120. The recovery TCP segment may be a TCP segment carrying the probe. The header of the recovery TCP segment may carry sequence number of each identified TCP segment having communication failures. The header of the recovery TCP segment may also include the length of payload of each identified TCP segment having communication failures. For example, when the second, the fourth and fifth of the transmitted five TCP segments have communication failures, the sequence number of the second, the fourth and fifth TCP segments are carried in the header of the recovery TCP segment. Furthermore, the length of payload of the second TCP segment, the length of payload of the third TCP segment, and the length of payload of the fifth TCP segment may also be carried in the header.

In block 210, one or more TCP segments having the communication failures are recovered by device 120. For example, processor 121 of device 120, when implementing a program in recovery module 122B, may recover payload of the one or more TCP segments that are not received by device 120 from the probe. Once the payload of the one or more TCP segments that are not received by device 120 are recovered, device 120 may determine that the one or more TCP segments that are not received by device 120 are recovered.

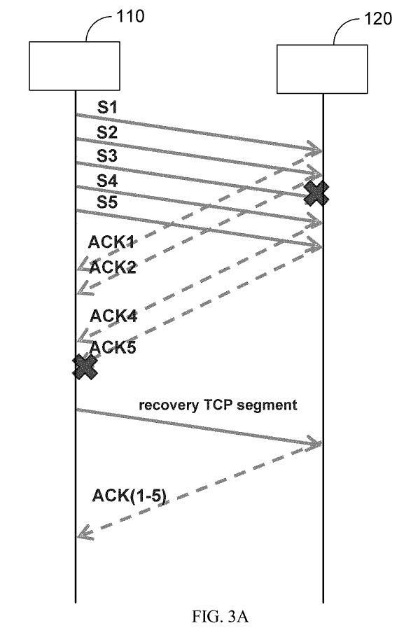

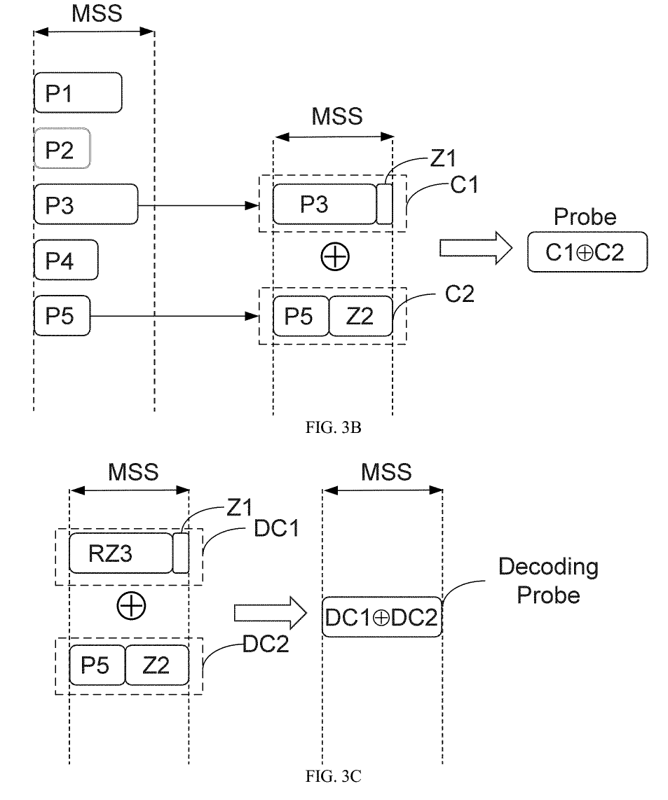

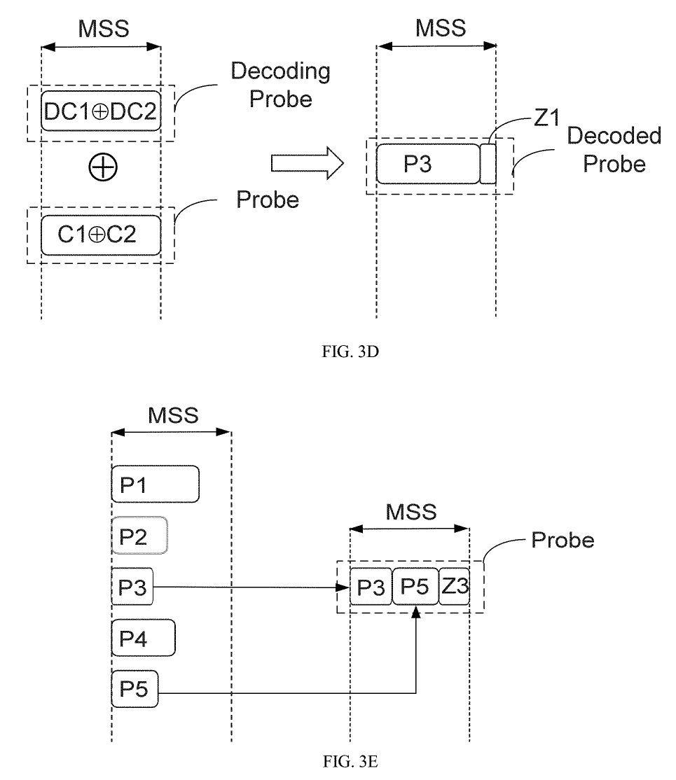

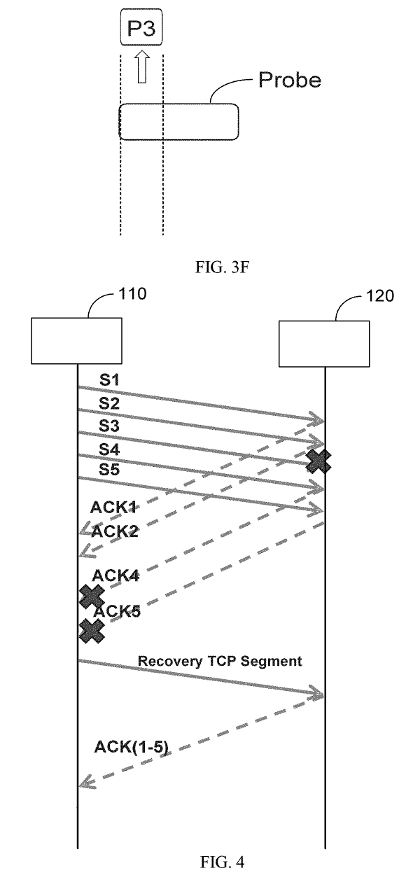

FIG. 3a illustrates a diagram showing the TCP segment transmission and acknowledgement between two devices in accordance with one embodiment of the present disclosure. In one embodiment, the two devices are device 110 and device 120 as described with respect to FIG. 1. As shown, device 110 may sequentially transmit five TCP segments, i.e., segment 1 (S1), segment 2 (S2), segment 3 (S3), segment 4 (S4), and segment 5 (S5), to device 120. After receiving a TCP segment from device 110, device 120 may send a response to device 110. In one embodiment, the response sent by device 120 is an acknowledgement (ACK). The ACK may carry information indicating which segment(s) are received by device 120.

In one embodiment, after receiving segments 1 and 2 (S1 and S2), device 120 may transmit two corresponding responses (ACK1 and ACK2) to device 110, where ACK1 is the response to S1 and ACK2 is the response to S2. As shown in FIG. 3a, segment 3 (S3) is not received by device 120. Accordingly, no acknowledgement will be generated by device 120 as a response to S3. There may be multiple reasons why device 120 fails to receive segment 3 (S3). For example, the segment 3 transmission failure may be caused by a transmission link failure between device 110 and device 120. In another example, the segment 3 transmission failure may be caused by the failure of device 120, such as the failure of a receiving port of device 120. In yet another example, the segment 3 transmission failure may be caused by an intermediate node (e.g., a switch or a router) between device 110 and device 120, by which S3 was dropped.

Returning back to FIG. 3a, segments 4 and 5 (S4 and S5), which are transmitted by device 110, are received by device 120. In response to segments 4 and 5, device 120 transmits ACK4 and ACK5 respectively to device 110. However, only ACK4 is received by device 110. The failure of receiving ACK5 may be caused by a link failure between device 110 and device 120, may be caused by a failure of device 110 or device 120, or may be caused by the delay of sending ACK5. Another reason for failing to receive ACK5 may be that ACK5 is dropped by an intermediate node (e.g., a switch or a router) between device 110 and device 120, after the ACK5 is sent by device 120. Thus, device 110 receives ACK1, ACK2 and ACK4, which respectively associate with TCP segments 1, 2 and 4, but fails to receive the ACKs in response to S3 and S5.

In one embodiment, the reception of an ACK by a transmission device, such as device 110, within a predefined receiving time period may indicate that a TCP segment that associates with the ACK is received by a destination device, such as device 120. Failing to receive an ACK within the predefined receiving time period may indicate that a TCP segment associated with the ACK fails to be received by a destination device, such as device 120. In one embodiment, when an ACK arrives at its destination, such as device 110, but fails to arrive within the predefined receiving time period, the ACK may be considered as not being received by the destination device.

There may be multiple methods for determining the receiving time period for each TCP segment transmitted by device 110. In one embodiment, all TCP segments to be transmitted may be associated with one common receiving time period, which may start from the time when any of the TCP segments is transmitted. For example, the receiving time period may be 1.5×Round Trip Time (RTT), 2×RTT, 2.5×RTT, or any other values, starting from the time when any of S1, S3 or S5 is transmitted. In another embodiment, each TCP segment may be associated with its own receiving time period. For example, time period i may represent a receiving time period for receiving ACKi associated with segment i (Si), where i is a natural number, such as 1, 2 or 3, etc. Thus, time period 1 is the receiving time period for receiving ACK1 associated with S1, and time period 2 is the receiving time period for receiving ACK2 associated with S2. Time period i may start at the time of transmitting Si. The length of time period i, e.g., time period 1, may be the same or different from the length of time period i+1, e.g., time period 2, where the length of time period i may be 1.5×RTT, 2×RTT, 2.5×RTT, or any other values.

The ACKs in FIG. 3a may be cumulative ACKs (CACKs) or selective ACKs (SACKs). When the ACKs are cumulative ACKs, ACK1 may carry acknowledgment information, e.g., an acknowledgment number in ACK1, indicating that S1 is received, and ACK2 may carry acknowledgment information, e.g., an acknowledgment number in ACK2, indicating S1 and S2 are received. Furthermore, ACK4 may carry acknowledgment information, e.g., an acknowledgment number in ACK4, indicating S1 and S2 are received. Although S4 is also received by device 120, ACK4 merely carries the same acknowledgement information as the one in ACK2, because S3 was not received by device 120. As such, device 110 may identify that S1 and S2 are received by device 120. As none of the ACKs received by device 110 indicates any of S3, S4 and S5 as being received by device 120, device 110 may identify S3, S4 and S5 as the TCP segments having communication failures. In one embodiment, the cumulative ACKs may simply be referred to as ACKs.

When the ACKs in FIG. 3a are selective ACKs, ACK1 may carry acknowledgment information indicating that S1 is received, and ACK2 may carry acknowledgment information indicating S1 and S2 are received. Furthermore, ACK4 may carry acknowledgment information indicating S1, S2 and S4 are received. As such, device 110 may identify that S1, S2 and S4 are received by device 120. As none of the ACKs received by device 110 indicates any of S3 and S5 as being received by device 120, device 110 may identify S3 and S5 as the TCP segments having communication failures.

In one embodiment, when a plurality of TCP segments are sequentially transmitted, each of the plurality of TCP segments includes a sequence number that is associated with the TCP segment. The sequence numbers of the plurality of segments indicate the transmission sequence of the plurality of TCP segments.

In one example, the sequence numbers of TCP segments S1-S5 in FIG. 3a are respectively 0, 100, 200, 300 and 400, and the ACKs received by device 110 in FIG. 3a are cumulative ACKs (CACKs). Thus, based on TCP, the acknowledgment information carried in ACK1 includes an acknowledgment number of 100, and the acknowledgment information carried in ACK2 includes an acknowledgment number of 200. The acknowledgment information carried in ACK4 is an acknowledgment number in ACK4, where the acknowledgment number in ACK4 is also 200. Because the acknowledgement numbers 100 and 200 in ACK1 and ACK2 associated with S1 and S2 respectively, device 110 may determine, based on the acknowledgement numbers in the received ACKs, that TCP segments S1 and S2 are received by device 120 and TCP segments S3-S5 have communication failures.

In another example, sequence numbers of TCP segments S1-S5 in FIG. 3a are respectively 0, 100, 200, 300 and 400, and the ACKs in FIG. 3a are selective ACKs (SACKs). The acknowledgment information carried in ACK1 may include an acknowledgment number and a selective ACK (SACK) option. The acknowledgment number in ACK1 is 100 indicating S1 is received by device 120, and the SACK option in ACK1 indicates that no other segments are received by device 120. The acknowledgment information carried in ACK2 may include an acknowledgment number and a SACK option. The acknowledgment number in ACK2 is 200 indicating S1 and S2 are received by device 120, and the SACK option in ACK2 indicates that no additional segments are received by device 120. The acknowledgment information carried in ACK4 may include an acknowledgment number and a SACK option. The acknowledgment number in ACK4 is 200 indicating S1 and S2 are received by device 120 and the SACK option in ACK4 indicates that S4 is also received by device 120. Thus, device 110 determines that S1, S2 and S4 are received by device 120, and that S3 and S5 have communication failures.

After identifying one or more TCP segments having communication failures, device 110 may generate a probe based on the identified TCP segments having communication failures. In particular, the probe may be generated by encoding the payload of the identified TCP segments having communication failures.

After the probe is generated, device 110 may transmit a recovery TCP segment to device 120, where the recovery TCP segment includes a TCP header and a TCP payload including the probe. Device 120 may recover the TCP segments which are not received by device 120, based on the probe.

In some embodiments, device 120 may not recover the TCP segments based on the probe. In this scenario, device 110 may not receive ACKs indicating all TCP segments transmitted by device 110 are received by device 120. Thus, device 110 may keep waiting until retransmission timeout (RTO) for the TCP segments having communication failures. Upon the occurrence of RTO, device 110 may retransmit the TCP segments having communication failures to device 120.

FIG. 3b illustrates a schematic diagram showing a method of generating a probe by encoding two TCP segments according to an embodiment of the present disclosure. As shown in FIG. 3b, P1-P5 may respectively represent the payloads of S1-S5 as illustrated in FIG. 3a. In the example shown in FIGS. 3a, S3 and S5 are identified as having communication failures. Thus, P3 and P5 may be used to generate probes.

In one embodiment, device 110 may determine whether the total length of P3 and P5 is longer than MSS. In one embodiment, the length of data (e.g., the length of a payload) may be measured by the number of bits in the data, such as 10 bits, 20 bits or 5 bytes. For example, the length of a payload may be 20 bits or 50 bits. The length of the data may also be referred to as size of the data.

In one embodiment, when the total length of P3 and P5 is longer than MSS, device 110 may generate, based on P3 and P5, two coded segments having the same length as MSS, respectively, and then generate a probe based on the two coded segments. In one example, for P3, a zero pad, hereinafter Z1, is inserted by device 110 to the end of P3 to obtain a first coded segment, hereinafter C1, having the same length as MSS. A zero pad may be a zero bit string, such as a bit string 000000. The length of Z1 is the difference between MSS and the length of P3. For example, if MSS is 30 bits long and P3 is 20 bits long, Z1 may be 10 bits long and the value of each of the 10 bits in Z1 is zero. For P5, device 110 may insert a second zero pad, hereinafter Z2, to the end of P5 to obtain a second coded segment, hereinafter C2, which has the same length as MSS. After obtaining C1 and C2, as illustrated in FIG. 3b, device 110 may perform Exclusive and OR (XOR) operation based on C1 and C2, to generate a probe having the same length as MSS. For example, when C1 is 1010111000 and C2 is 1101100000, the probe is 0111011000. After the probe is generated, device 110 sends device 120 a recovery TCP segment carrying the probe. The recovery TCP segment may carry a sequence number for each of the one or more segments used for generating the probe in its TCP header, such as the sequence numbers of TCP segments 3 and 5. Furthermore, the TCP header of the recovery TCP segment may include the length of payload of each segment identified by the one or more sequence numbers, such as length of P3 and length of P5. Because one TCP segment may have one payload and one TCP header, a sequence number of a TCP segment may also be referred to as the sequence number of the payload of the TCP segment. For example, a sequence number of segment 3 may also be referred to as a sequence number of P3.

FIG. 3c illustrates a schematic diagram of generating a decoding probe according to an embodiment of the present disclosure. According to the sequence numbers and the length carried in the TCP header, device 120 may determine which segment or segments are used to generate the probe and also determine the length of the payload of each segment used to generate the probe. For example, when the sequence numbers of S3 and S5, the length of P3, and the length of P5 are carried in the TCP header, device 120 may determine that P3 and P5 are used to generate the probe and also determine the length of P3 and length of P5.

In order to decode the probe, device 120 may generate a decoding probe by using a rule same as or similar to the forgoing rule used by device 110 to generate the probe. The rule may be pre-configured at device 120 by a network controller in the network 100 or received from device 110. Consequently, as shown in FIG. 3c, device 120 generates a zero pad (RZ3), where RZ3 has the same length as P3. Based on RZ3 and payload of S5 (P5), device 120 generates the decoding probe. For example, Z1 may be inserted to the end of RZ3 to generate a coded segment for decoding, hereinafter DC1. Z2 may be inserted to the end of P5 to obtain another coded segment for decoding, hereinafter DC2, where DC2 is identical to C2 illustrated in FIG. 3b. Then, XOR operation based on DC1 and DC2 is performed to obtain a decoding probe. Because the length of each of DC1 and DC2 is the same as MSS, the decoding probe has the same length as one in the probe.

FIG. 3d illustrates a schematic diagram showing the recovery of the payload of a TCP segment according to an embodiment of the present disclosure. The TCP segment payload recovery may be performed by device 120 as illustrated in FIGS. 1 and 3a. During the payload recovery, device 120 may perform XOR operation based on the probe and the decoding probe to obtain a decoded probe. As illustrated in FIG. 3d, the decoded probe includes P3 and Z1. Because the position of P3 in the decoded probe is the same as the one of RZ3 in DC1, device 120 retrieve P3 from the decoded probe based on DC1.

FIG. 3e illustrates another schematic diagram of generating a probe according to an embodiment of the present disclosure. When the total length of P3 and P5 is shorter than MSS, device 110 may insert P5 to the end of P3, and then add a zero pad, hereinafter Z3, to the end of P5 to obtain a probe having the same length as MSS. Device 110 may send device 120 a recovery TCP segment carrying the probe as illustrated in FIG. 3e. The header of the recovery TCP segment includes the sequence numbers of S3 and S5, and also the length of P3, and the length of P5.

FIG. 3f illustrates another schematic diagram showing the recovery of the payload of a TCP segment according to an embodiment of the present disclosure. After the recovery TCP segment is received, device 120 may obtain the sequence numbers of S3 and S5, the length of P3, and length of P5 from the recovery TCP segment. Because device 120 has the knowledge of the method for generating the probe, based on the sequence number of S3, the length of P3, and the method for generating the probe, device 120 may consequently obtain the position of P3 in the probe. For example, device 120 may determine that P3 is a portion of the probe, where this portion starts at the beginning of the probe and has the same length as P3. Thus, as illustrated in FIG. 3f, device 120 may retrieve P3 from the probe.

If the total length of P3 and P5 is the same as MSS, device 110 may insert P5 to the end of P3 to obtain a probe having the same length as MSS. A recovery TCP segment sent from device 110 to device 120 may carry the probe in its payload, and carry the sequence numbers of the S3 and S5, the length of P3, and length of P5 in its TCP header. Similar to what is illustrated in FIG. 3f, device 120 may retrieve P3 from the probe.

FIG. 4 illustrates a schematic diagram showing the recovery of payloads of TCP segments according to one embodiment of the present disclosure. As shown, a group of TCP segments (S1, S2, S3, S4, and S5) are transmitted in sequence by device 110 to device 120.

After S1 and S2 are received, device 120 transmits ACK1 and ACK2 to device 110, where ACK1 is the response to S1 and ACK2 is the response to S2. ACK1 may carry acknowledgment information, such as an acknowledgment number, indicating that S1 is received. ACK2 may carry acknowledgment information, such as an acknowledgment number, indicating that S1 and S2 are received.

In one embodiment, S3 transmitted by device 110 fails to be received by device 120. Accordingly, no response associated with S3, such as ACK3, is generated by device 120. As shown, the transmitted S4 and S5 are received by device 120. In response, device 120 transmits ACK4 and ACK5 to device 110, where ACK4 is a response to S4 and ACK5 is a response to S5. However, due to some transmission failures of ACK4 and ACK5, ACK4 and ACK5 are not received by device 110. In an example, the transmission failures of ACK4 and ACK5 may be caused by a link failure between device 110 and device 120. In another example, the transmission failures of ACK4 and ACK5 may be caused by the failure of device 120, such as the failure of a port of device 120, which is used to transmit data to device 110. In yet another example, the transmission failures of ACK4 and ACK5 may be caused by an intermediate node (e.g., a switch or a router) between device 110 and device 120 after the intermediate node dropped ACK4 and ACK5. In an embodiment, a message, such as a TCP segment or an ACK, is received may mean that the message is received within a predefined receiving time period associated with the message. A message is not received may mean that the message is not received within the receiving time period associated with the message. For example, ACK1 and ACK2 are received may refer to ACK1 and ACK2 are received within a common receiving time period shared by the two ACKs or within two receiving time periods respectively associated with the two ACKs.

As such, device 110 receives ACK1 and ACK2 and does not receive ACK3, ACK4, and ACK5. Therefore, device 110 identifies that S1 and S2 are received by device 120 and S3, S4 and S5 are the TCP segments having communication failures. After identifying S3-S5 are the TCP segments having communication failures, device 110 may generate a probe based on S3-S5. The probe may be generated by encoding each payload of S3-S5, such as P3, P4 and P5 respectively associated with S3, S4 and S5. After the probe is generated, device 110 may transmit a recovery TCP segment carrying the probe to device 120.

Device 120 may recover P3 according to the received probe and P4 and P5. After the P3 is recovered, device 120 transmits an ACK identifying that S1-S5 are received by the device 120 to device 110. The ACK identifying the reception of S1-S5 is presented as the ACK(1-5) in FIG. 4.

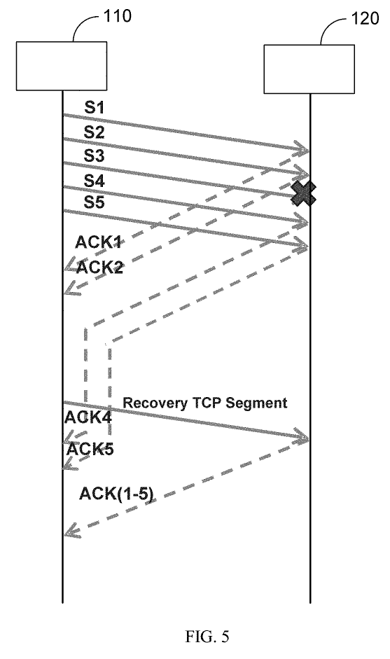

FIG. 5 illustrates a schematic diagram showing the recovery of TCP segments according to one embodiment of the present disclosure. As shown, device 110 transmits a group of TCP segments, such as S1, S2, . . . S5, to device 120 one by one in sequence.

After S1 and S2 are received, device 120 transmits ACK1 and ACK2 as responses respectively associated to S1 and S2 to device 110. ACK1 may carry acknowledgment information, such as an acknowledgment number, indicating that S1 is received. ACK2 may carry acknowledgment information, such as an acknowledgment number, indicating that S1 and S2 are received. In one embodiment, S3 transmitted by device 110 is not received by device 120. Accordingly, no response associated with S3, such as ACK3, is generated by device 120. As shown, the transmitted S4 and S5 are received by device 120. In response, device 120 transmits ACK4 and ACK5, which are respectively associated with S4 and S5, to device 110. However, transmission of ACK4 and ACK5 is delayed so that they do not arrive at device 110 within the predefined receiving time period. The delay may be caused by a temporary link failure or link congestion between device 110 and device 120. In another example, the delay of ACK4 and ACK5 may be caused by the temporary failure or congestion of device 120, such as the temporary failure or congestion of a port of device 120 which is used to send ACKs to device 110.

Thus, ACK4 and ACK5 are regarded as not being received by device 110. In an example, receiving a message, such as a TCP segment or an ACK, may refer to receiving the message within a receiving time period associated with the message. For example, receiving ACK1 and ACK2 refers to receiving ACK1 and ACK2 within one receiving time period shared by the two ACKs or within two receiving time period respectively associated with the two ACKs. As such, after receiving ACK1 and ACK2, device 110 identifies that S1 are S2 are received by device 120 and S3-S5 are TCP segments having communication failures. After identifying S3-S5 as the TCP segments having communication failures, device 110 may generate a probe based on S3-S5. The probe may be generated by encoding each payload of S3-S5, such as P3, P4 and P5 respectively associated with S3, S4 and S5. After the probe is generated, device 110 may transmit a recovery TCP segment carrying the probe to device 120. In an embodiment, a message, such as a TCP segment or an ACK, is received may mean that the message is received within a predefined receiving time period associated with the message. A message is not received may mean that the message is not received within the receiving time period associated with the message. For example, ACK1 and ACK2 are received may refer to ACK1 and ACK2 are received within a common receiving time period shared by the two ACKs or within two receiving time periods respectively associated with the two ACKs.

Device 120 may recover P3 according to the received probe, P4 and P5. After P3 is recovered, device 120 transmits an ACK identifying that S1-S5 are received by the device 120 to device 110. The ACK identifying S1-S5 is received is presented as ACK(1-5) in FIG. 5.

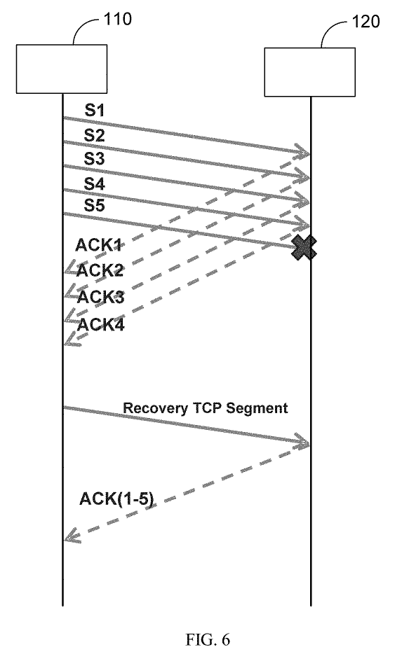

FIG. 6 illustrates a diagram showing the recovery of the payloads of TCP segments according to one embodiment of the present disclosure. As shown, device 110 transmits a group of TCP segments, such as S1, S2, . . . S5, to device 120 one by one in sequence.

After S1-S4 are received, device 120 transmits ACK1-ACK4 to device 110, where ACK1 carries information indicating that S1 is received, ACK2 carries information indicating that S1-S2 are received, ACK3 carries information indicating that S1-S3 are received and ACK4 carries information indicating S1-S4 are received. However, due to some transmission failures, S5 fails to be received by device 120. Accordingly, no response associated with S5, such as ACK5, is generated by device 120. Thus, device 110 receives ACK1-ACK4 and fails to receive the ACK associated with S5 (ACK5). In an example, the transmission failures of S5 may be caused by a link failure between device 110 and device 120. In another example, the transmission failure of S5 may be caused by the failure of device 120, such as the failure of a port of device 120, which is used to receive data from device 110. In yet another example, the transmission failing of S5 may be caused by an intermediate node (e.g., a switch or a router) between device 110 and device 120 after the intermediate node dropped S5. As such, device 110 identifies that S1-S4 are received and S5 is identified as the TCP segment having the communication failure. In an embodiment, a message, such as a TCP segment or an ACK, is received may mean that the message is received within a predefined receiving time period associated with the message. A message is not received may mean that the message is not received within the receiving time period associated with the message. For example, ACK1 and ACK2 are received may refer to ACK1 and ACK2 are received within a common receiving time period shared by the two ACKs or within two receiving time periods respectively associated with the two ACKs.

After identifying S5 is the TCP segment having communication failures, device 110 may generate a probe based on S5. In an example, the probe may be generated by inserting a zero pad to the end of payload of S5, hereinafter P5, to obtain a coded segment having the same length as MSS. In another example, the probe may be P5 itself when the length of P5 is the same as MSS. After the probe is generated, device 110 may transmit a recovery TCP segment carrying the probe to device 120.

Device 120 may recover P5 according to the probe. After P5 is recovered, device 120 transmits an ACK identifying that S1-S5 are received by device 120 to device 110. The ACK identifying S1-S5 is received is presented as ACK(1-5) in FIG. 6.

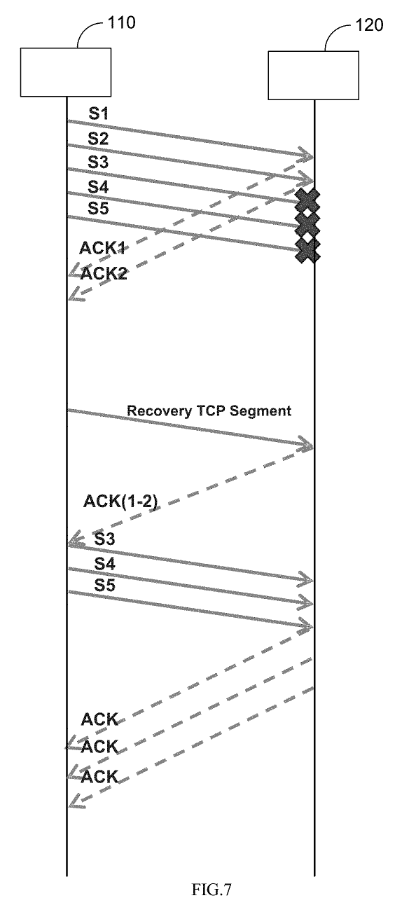

FIG. 7 illustrates a schematic diagram showing the recovery of TCP segments according to one embodiment of the present disclosure. As shown, device 110 transmits a group of TCP segments, such as S1, S2, . . . S5, to device 120 in sequence.

After S1-S2 are received, device 120 transmits ACK1 and ACK2 to device 110, where ACK1 carries acknowledgement information, such as an acknowledgement number, indicating that S1 is received, and ACK2 carries acknowledgement information, such as an acknowledgement number, indicating that S1-S2 are received. However, due to some transmission failures, S3-S5 are not received by device 120. Accordingly, no responses associated with S3-S5 are generated by device 120. In an embodiment, a message, such as a TCP segment or an ACK, is received may mean that the message is received within a predefined receiving time period associated with the message. A message is not received may mean that the message is not received within the receiving time period associated with the message. For example, ACK1 and ACK2 are received may refer to ACK1 and ACK2 are received within a common receiving time period shared by the two ACKs or within two receiving time periods respectively associated with the two ACKs.

As such, device 110 receives ACK1 and ACK2 and fails to receive any responses to S3-S5. Therefore, device 110 identifies that S1-S2 are received and S3-S5 are identified as the TCP segments having communication failures. After identifying S3-S5 as the TCP segments having communication failures, device 110 may generate a probe based on S3-S5. For example, the probe is generated based on each payload of S3-S5, such as P3, P4 and P5 respectively associated with S3, S4 and S5. Based on the generated probe, device 110 may transmit a recovery TCP segment carrying the probe to device 120.

In this embodiment, device 120 may not recover the S3-S5 based on the recovery TCP segment. In this situation, device 120 transmit an ACK(1-2) as the response to the recovery TCP segment to device 110, where the ACK(1-2) indicates that S1-S2 are received by device 120. After device 110 receives the ACK(1-2) as a duplicate, device 110 triggers TCP fast retransmission phase. For example, device 110 may re-transmit S3-S5 one by one in sequence. After S3-S5 are received by device 120, device 120 transmits three ACKs as responses to S3-S5, where those three ACKs indicate that S3-S5 are received by device 120.

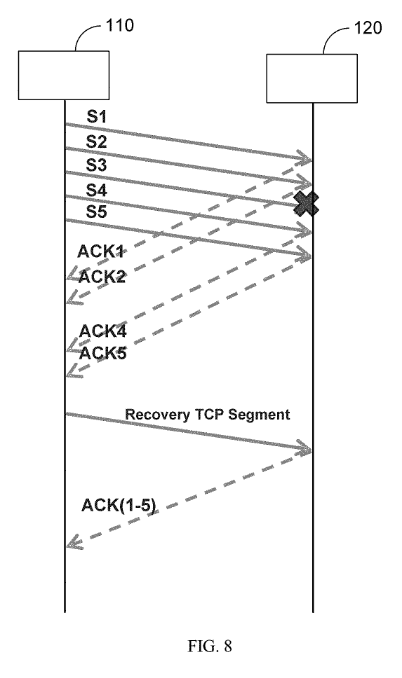

FIG. 8 illustrates a schematic diagram showing the recovery of TCP segments according to one embodiment of the present disclosure. Device 110 transmits a group of TCP segments, such as S1, S2, S3, S4, and S5 as illustrated in FIG. 8, to device 120 one by one in sequence.

After S1-S2 are received, device 120 transmits ACK1-ACK2 to device 110, where ACK1 carries acknowledgement information, such as an acknowledgement number, indicating that S1 is received, ACK2 carries acknowledgement information, such as an acknowledgement number, indicating that S1-S2 are received. Due to some transmission failures, S3 is not received by device 120. Consequently, no response associated with S3 is generated by device 120. After S4-S5 are received, device 120 transmits ACK4 and ACK5 to device 110. In an embodiment, all ACKs may be selective acknowledgements (SACKs). ACK4 may carry information indicating that S1-S2 and S4 are received by device 120, ACK5 may carry information indicating that S1-S2 and S4-S5 are received by device 120. As such, device 110 may identify that S1-S2 and S4-S5 are received by device 120 and S3 is a TCP segment having communication failures.

In an embodiment, a message, such as a TCP segment or an ACK, is received may mean that the message is received within a predefined receiving time period associated with the message. A message is not received may mean that the message is not received within the receiving time period associated with the message. For example, ACK1 and ACK2 are received may refer to ACK1 and ACK2 are received within a common receiving time period shared by the two ACKs or within two receiving time periods respectively associated with the two ACKs.

After identifying S3 as the TCP segment having communication failure, device 110 may generate a probe based on S3. For example, the probe is generated based on the payload of S3, e.g., P3. Based on the generated probe, device 110 may transmit a recovery TCP segment carrying the probe to device 120. In an example, the probe may be generated by inserting a zero pad to the end of payload of S3, hereinafter P3, to obtain a coded segment having the same length as MSS. In another example, the probe may be P3 itself. After the probe is generated, device 110 may transmit a recovery TCP segment carrying the probe to device 120.

Device 120 may recover P3 based on the probe. After P3 is recovered, device 120 transmits an ACK identifying that S1-S5 are received by the device 120 to device 110. The ACK identifying that S1-S5 are received is presented as ACK(1-5) in FIG. 8.

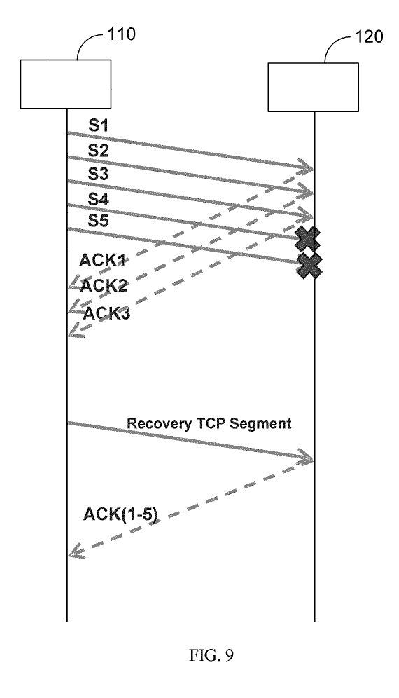

FIG. 9 illustrates a schematic diagram showing the recovery of TCP segments according to one embodiment of the present disclosure. Device 110 transmits a group of TCP segments, such as S1, S2, S3, S4, and S5, as illustrated in FIG. 9, to device 120 one by one in sequence.

After S1-S3 are received, as illustrated in FIG. 9, device 120 transmits ACK1-ACK3 to device 110, where ACK1 may carry acknowledgement information, such as an acknowledgement number, indicating that S1 is received, ACK2 may carry acknowledgement information, such as an acknowledgement number, indicating that S1-S2 are received, ACK3 may carry acknowledgement information, such as an acknowledgement number, indicating that S1-S3 are received. Due to some transmission failures, S4 and S5 are not received by device 120. Consequently, no responses associated with S4 and S5 are generated by device 120. As such, device 110 may identify that S1-S3 are received by device 120 and S4-S5 are the TCP segments having communication failures. In an embodiment, a message, such as a TCP segment or an ACK, is received may mean that the message is received within a predefined receiving time period associated with the message. A message is not received may mean that the message is not received within the receiving time period associated with the message. For example, ACK1 and ACK2 are received may refer to ACK1 and ACK2 are received within a common receiving time period shared by the two ACKs or within two receiving time periods respectively associated with the two ACKs.

After identifying S4 and S5 as the TCP segments having communication failure, device 110 may generate a probe based on S4 and S5. For example, the probe may be generated by encoding payloads of S4 and S5, such as P4 and P5 respectively associated with S4 and S5. In this embodiment, the total length of P4 and P5 is shorter than or equal to MSS. Based on the probe, device 110 may transmit a recovery TCP segment carrying the probe to device 120. After receiving the recovery TCP segment, device 120 may recover the payloads of S4 and S5 based on the probe, because the total length of P4 and P5 is shorter than or equal to MSS. After recovering the payloads of S4 and S5, device 120 transmits an ACK identifying that S1-S5 are received by the device 120 to device 110. The ACK identifying that S1-S5 are received is presented as ACK(1-5) in FIG. 9.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

Although the processes or methods are described above in terms of some sequential operations, it should be appreciated that some of the operations described may be performed in a different order. Moreover, some operations may be performed in parallel rather than sequentially.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A device comprising:
a memory storage comprising computer-executable instructions; and
a processor coupled to the memory storage, wherein the processor is configured to execute the instructions to:
transmit a plurality of transmission control protocol (TCP) segments to a receiving device one by one in sequence;
receive one or more TCP responses sent by the receiving device, wherein the one or more TCP responses are associated with the plurality of TCP segments;
identify one or more TCP segments having communication failures based on the received one or more TCP responses;
generate a probe based on the identified one or more TCP segments; and
transmit a recovery TCP segment carrying the probe to the receiving device.

2. The device of claim 1, wherein the one or more TCP responses include acknowledgment information indicating which TCP segment or segments are received by the receiving device and the one or more TCP segments having communication failures are identified based on the acknowledgment information.

3. The device of claim 1, wherein the acknowledgment information comprises one or more acknowledgment numbers.

4. The device of claim 3, wherein identification of the one or more TCP segments comprises:
identifying one or more TCP segments indicated by the acknowledgment numbers of the received one or more TCP responses as received TCP segments; and
identifying difference between the plurality of TCP segments and the received TCP segments as the one or more TCP segments having communication failures.

5. The device of claim 1, wherein the one or more TCP responses are one or more acknowledgments (ACKs).

6. The device of claim 5, wherein the ACKs are Selective ACKs (SACKs) or Cumulative ACKs (CACKs).

7. The device of claim 1, wherein the probe is generated by encoding the one or more TCP segments.

8. The device of claim 1, wherein each of the one or more TCP responses is associated with one of the plurality of TCP segments, and the each of the one or more received TCP responses is received within a pre-defined receiving time period.

9. The device of claim 8, wherein the pre-defined receiving time period is 2×Round Trip Time (RTT) that starts from a time when a TCP segment associated with the pre-defined receiving time period is transmitted from the device to the receiving device.

10. A method for recovering TCP segments, comprising:
transmitting, by a transmitting device, a plurality of transmission control protocol (TCP) segments to a receiving device one by one in sequence;
receiving, by the transmitting device, one or more TCP responses transmitted by the receiving device, wherein the one or more TCP responses are associated with the plurality of TCP segments;
identifying, by the transmitting device, one or more TCP segments having communication failures based on the received one or more TCP responses;
generating, by the transmitting device, a probe based on the identified one or more TCP segments; and
transmitting, by the transmitting device, a recovery TCP segment having the probe to the receiving device.

11. The method of claim 10, wherein the one or more TCP responses include acknowledgment information indicating which TCP segment or segments are received by the receiving device.

12. The method of claim 11, wherein the identifying, by the transmitting device, one or more TCP segments having communication failures based on the received one or more TCP responses comprises:
identifying the one or more TCP segments having communication failures based on the acknowledgement information.

13. The method of claim 11, wherein the acknowledgment information comprises one or more acknowledgment numbers.

14. The method of claim 13, wherein the identifying, by the transmitting device, one or more TCP segments having communication failures based on the received one or more TCP responses comprises:
identifying one or more TCP segments indicated by the acknowledgment numbers of the received one or more TCP responses as received TCP segments; and
identifying difference between the plurality of TCP segments and the received TCP segments as the one or more TCP segments having communication failures.

15. The method of claim 10, wherein the one or more TCP responses are one or more acknowledgements (ACKs).

16. The method of claim 15, wherein the ACKs are Selective ACKs (SACKs) or Cumulative ACKs (CACKs).

17. The method of claim 10, wherein the probe is generated by encoding the one or more TCP segments.

18. The method of claim 10, wherein each of the one or more TCP responses is associated with one of the plurality of TCP segments, and the each of the one or more received TCP responses is received within a pre-defined receiving time period.

19. The method of claim 10, wherein the receiving time period is 2×Round Trip Time (RTT) that starts from a time when a TCP segment associated with the pre-defined receiving time period is transmitted from the device to the receiving device.

20. A non-transitory computer readable medium storing computer readable instructions which, when executed by a processor, cause the computer to perform a method, the method comprising:
transmitting a plurality of transmission control protocol (TCP) segments to a receiving device one by one in sequence;
receiving one or more TCP responses sent by the receiving device, wherein the one or more TCP responses are associated with the plurality of TCP segments;
identifying one or more TCP segments having communication failures based on the received one or more TCP responses;
generating a probe based on the identified one or more TCP segments; and
transmitting a recovery TCP segment having the probe to the receiving device.
